(19) United States
(12) Patent Application Publication
(10) Pub. No.: US 2021/0293260 A1
(43) Pub. Date: Sep. 23, 2021

(54) Plug Restrictor with surface channel(s)

(71) Applicant: Guanghua WU, McKinney, TX (US)

(72) Inventor: Guanghua WU, McKinney, TX (US)

(21) Appl. No.: 16/974,650

(22) Filed: Mar. 25, 2019

(51) Int. Cl. F15D 1/06

(52) U.S. Cl. CPC F15D 1/065

(57) ABSTRACT

A plug restrictor has surface channel(s) made by etching or other means. The plug is either tapered to match with the tapered bore in the flow apparatus or straight to match with the straight bore of the flow apparatus. By pressing the plug restrictor into the bore of the flow apparatus, the restricting passageway(s) is(are) formed between the channel(s) on the plug surface and the inner peripheral surface of the bore of the flow apparatus.

### FIELD OF THE INVENTION

The present invention is related to plug restrictors used by flow apparatuses.

### BACKGROUND OF THE INVENTION

Plug restrictor is an annual gap laminar flow element, due to its simplicity and inexpensiveness, has been widely used in flow apparatuses.

FIG. 1 is a sketch showing how plug restrictor works. The restrictor 1 is a plug or a cylinder with a diameter D. Fluid flows in from inlet 3, passing the gap formed between plug restrictor 1 and the bore, flows out from outlet 4. A portion of the fluid may flow into the measuring device, such as thermal sensor, through port 5 and come back through port 6. The restrictor 1 proposes a restriction to the flow and at the same time, makes the flow through the gap laminar. The pressure drop across the restrictor is equal to the pressure drop between port 5 and 6 dictated by the pressure drop of the measuring device. As the characteristic of laminar flow, the pressure drop across the restrictor is linear to the flow rate.

FIG. 1 does not show how the plug restrictor is supported. There are several ways to support the plug restrictor and maintain the annular gap between the plug and the bore of the flow apparatuses. One way is to attach spacing wires, or pins, or integrated ribs to the plug, then press the plug into the bore of the flow apparatus to form an annual gap. The size of the wires, pins or ribs will decide the thickness of the gap. Another way is to support the plug by nuts on one or both ends.

In semiconductor and other applications, sometimes the required flow rates are very small. For a thermal-sensor-based mass flowmeter, the required minimum flow rate range can be less than 10 sccm (standard cubic centimeters per minute) at a pressure drop of 5 to 10 torr. For a pressure-based mass flowmeter, the required minimum flow rate ranges can be less than 5 sccm at a pressure drop of 20 torr to 1 psid. The pressure drop of a circular gap flow of a restrictor can be expressed as

$$Δ p = \frac{K \dot{m} L}{{t}^{3} ( D + t )} , \qquad ( 1 )$$

where Δp is the pressure drop between the upstream and downstream of the restrictor, K is a constant, \dot{m} is the flow rate, L is the length of the restrictor, D is the diameter of the restrictor and t is the gap thickness. As the L and Dare fixed and limited, to satisfy the required pressure drop at a very small flow rate, the only dimension can be used to adjust the pressure drop is the gap thickness and it needs to be very small. As an example, for a restrictor with a length 0.75″, a diameter 0.375″, at 5 sccm, to get a 5 torr pressure drop, the gap needs to be around 0.001″. Considering the diameter tolerances for the bore and the restrictor are at a level of ±0.001″ without extra manufacturing expense, to maintain a 0.001″ gap is very hard. The dispersion of the gap dimension will make the consistency of the product very hard to control.

Some restrictors have a tapered portion. The pressure drop can be adjusted and increased by pushing the restrictor to narrow the gap. But for this kind of design, it is very easy to push the restrictor too much, block the flow passage and ruin the product. Some of the plug restrictor designs are forced to use other kind of structure, such as tube restrictor when the flow rate is very low. The tube restrictor is more expensive, and may still not get enough pressure drop, as the restrictor tube is shorter than the thermal sensor tube.

One of the objectives of this invention is to provide a plug restrictor which can provide enough pressure drop at very low flow rate without losing its ability to work at higher flow rate.

Another objective of this invention is to eliminate the gap between the restrictor and the bore of the flow apparatuses, to reduce the manufacturing and installation cost.

### SUMMARY OF THE INVENTION

In one aspect, instead of maintaining a gap between the restrictor and the bore of the flow apparatus, the flow passage(s) is (are) provided by etched channel(s) on the surface of the restrictor. The restrictor is press-fitted to the bore of the flow apparatus without a gap. The etched channel(s) on the restrictor surface will form flow passage(s) with the inner peripheral surface of the bore of the flow apparatus.

### BRIEF DESCRIPTION OF THE DRAWINGS

FIG. 1 is a sketch showing the work principle of a plug restrictor.

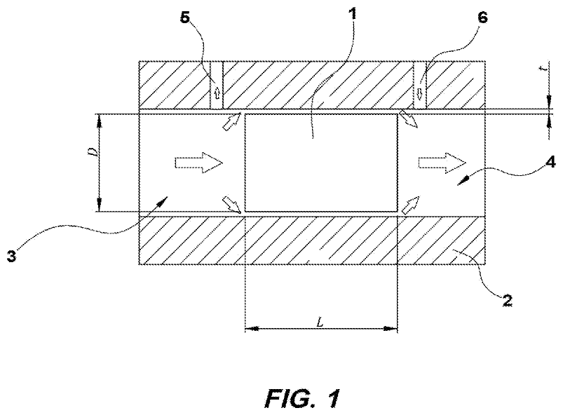

FIG. 2A is a perspective view of the etched restrictor of this invention, FIG. 2B is the section view of the channel profile and FIG. 2C is a perspective view of a restrictor of this invention with straight channels.

FIG. 3A is a perspective view showing the restrictor has been pressed into the bore of a flowmeter base. FIG. 3B is a section view of FIG. 3A.

FIG. 4 is a section view showing the setup of the taper angle measurement of restrictor bore.

FIG. 5 is a section view showing the slots in the base side of a flowmeter.

FIG. 6 is a section view showing the slots in the restrictor side of a flowmeter.

### DETAILED DESCRIPTION OF THE INVENTION

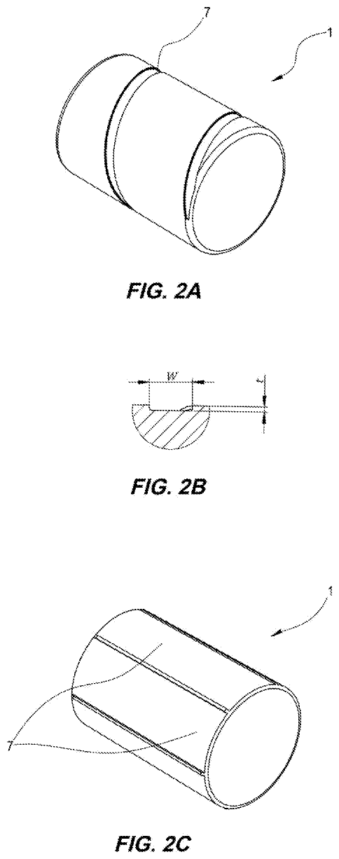

FIG. 2A shows one of the embodiments of this invention. Restrictor 1 is a tapered cylinder made of metal compatible to the medium that may come in contact with the component, and exemplary materials is 316L stainless steel. A channel or slot 7 is etched on the restrictor surface. The trajectory of the channel is a hex curve (can be other kind of curves). The section dimensions (width W and channel depth t shown in FIG. 2B) will be decided by the requirement of Reynolds number. A satisfactory flow rate and pressure drop result can be obtained by adjusting the pitch of the hex curve, section dimensions of the channel and number of the channels. For example, for a restrictor of 0.75″ long and 0.5″ in diameter, to satisfy a 5 torr pressure drop at 5 sccm flow rate, a dimension combination can be: the pitch of the hex curve around 0.4″ (this will make the length of the flow passage L around 2.6″), the depth of the slot t as 0.006″ and the width Was 0.05″. This example also shows that this kind flow passage can satisfy much higher pressure drop requirement just by making the pitch smaller.

Although the etched restrictor of this invention is especially good at low flow rate, as shown in FIG. 2C for another embodiment of this invention, by using straight multiple channel pattern, the flow rate range can be increased to cover much higher flow rate, just as regular plug restrictors, without the needing for expensive spacing wires or ribs.

Other than etching, the channel(s) can also be made by machining or other means.

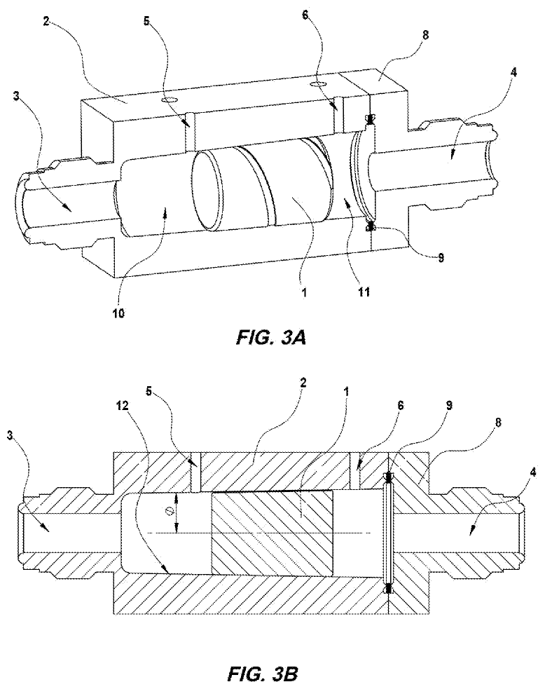

FIG. 3A is a perspective view showing restrictor 1 has been pressed into a bore of a flowmeter base 2. The bore is tapered to the same angle as restrictor 1. A flange 8 made of the equivalent metal as restrictor is bolted to base 2 with a metal gasket 9 to provide a sealing between them. The bore of the base 2 is divided by restrictor 1 into upstream chamber 10 and downstream chamber 11. Fluid flows into chamber 10 through inlet 3 provided by base 2 and leave the flowmeter though outlet 4 provided by flange 8. Taps 5 and 6 communicate with either thermal sensor, or pressure transducer or some kind of sensing devices (not shown in this drawing). As the restrictor is airtightly pressed, generally, the leaking through the contact surfaces between the outer peripheral surface of the restrictor 1 and the inner peripheral surface of the bore is ignorable. All the fluid, other than the portion flowing through the thermal sensor or other kind of measuring devices, can be thought to flow only through the channel(s) formed by the surface channel(s) on restrictor 1 and the inner surface 12 of the base bore (shown on FIG. 3B).

Referring to FIG. 3B, the taper angle of restrictor 1 can be expressed as Φ. Smaller the angle, tighter the contact. If the angle is too small, the restrictor will be hard to dismount if needed and the axial location is less certain due to the diameter tolerance. As a reference, the taper angles for machine tool spindles are between 1.19° to 2.4°, and the mountings are called “self-holding”. As the restrictors are much less dismountable required, an angle around 0.5° to 1° should be appropriate.

To have a secure connection between two taper surfaces, other than a small taper angle, the two matched taper angles should be as identical as possible. This will require an accurate measurement of the taper angles. Comparing with the male taper angle, the female taper angle is more difficult to measure.

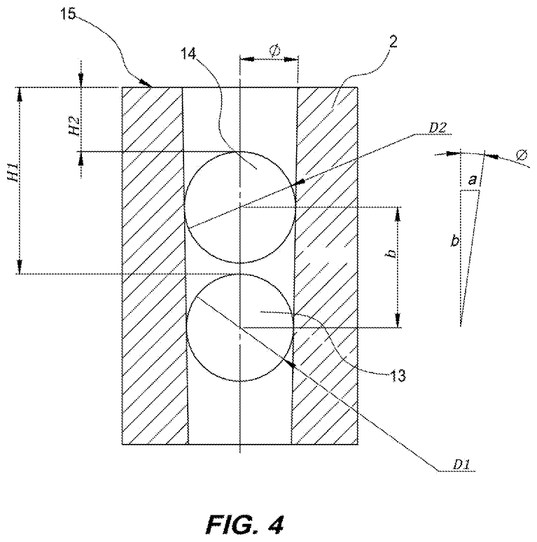

A measurement method using two balls can be used to measure the female taper angle. It can be explained with the of FIG. 4. In FIG. 4, 2 is the base to be measured, 13 and 14 are two steel balls with different diameters, 13 is the smaller ball with a known diameter D1 and 14 is the bigger ball with a known diameter D2. H1 and H2 are the distances from the top plane 15 to the tops of the balls measured by a depth micrometer, respectively. In the sketched triangle on the right, we have

$$\begin{matrix}a = \frac{D 2 - D 1}{2} , & ( 2 ) \\ b = H 1 - H 2 + D 1 / 2 - D 2 / 2 , \\ and & ( 3 ) \\ Φ = atan ( \frac{a}{b} ) . & ( 4 )\end{matrix}$$

The uncertainty of Φ depends on the uncertainties of measurements D1, D2, H1, and H2. With a regular micrometer, ignoring measuring operation error, the absolute uncertainties of D1 and D2, assigned as σ_{D} and σ_{d}, should be ±0.0001″. With a depth micrometer, also ignoring measuring operation error, the absolute uncertainties of H1 and HZ, assigned as σ_{H1} and σ_{H2}, should be ±0.00012″. According to measurement error analysis principle, when adding (or subtracting) independent measurements, the absolute uncertainty of the sum (or difference) is the root sum of the squares (RSS) of the individual absolute uncertainties. That is

$$\begin{matrix}\begin{matrix}{σ}_{a} = \sqrt{{σ}_{D 1}^{2} + {σ}_{D 2}^{2}} \\ = \sqrt{{0.00012}^{′′ 2} + {0.00012}^{′′ 2}} \\ = {0.0001697}^{′′} ,\end{matrix} \\ and & ( 5 ) \\ \begin{matrix}{σ}_{b} = \sqrt{{σ}_{H 1}^{2} + {σ}_{H 2}^{2} + {σ}_{D 1}^{2} + {σ}_{D 2}^{2}} \\ = \sqrt{{0.0001}^{′′ 2} + {0.0001}^{′′ 2} + {0.00012}^{′′ 2} + {0.00012}^{′′ 2}} \\ = {0.000209}^{′′} .\end{matrix} & ( 6 )\end{matrix}$$

If we use f to represent a/b, also according to measurement error analysis principle, when multiplying (or dividing) independent measurements, the relative uncertainty of the product (quotient) is the RSS of the individual relative uncertainties, the relative uncertainty of f can be written as

$$\frac{{σ}_{f}}{f} = \sqrt{{( \frac{{σ}_{a}}{a} )}^{2} + {( \frac{{σ}_{b}}{b} )}^{2}} . \qquad ( 7 )$$

As an example, we use the dimensions in FIG. 3 (H1=0.889″, H2=0.306″, D1=0.51″ and D2=0.53″) to get a=0.01″ and b=0.573″, then plug into Equation (6),

$$\begin{matrix}\begin{matrix}\frac{{σ}_{f}}{f} = \sqrt{{( \frac{{0.0001697}^{′′}}{{0.01}^{′′}} )}^{2} + {( \frac{{0.000209}^{′′}}{{0.573}^{′′}} )}^{2}} \\ = 0.01697 ,\end{matrix} \\ and & ( 8 ) \\ \begin{matrix}{σ}_{f} = 0.01 \; 6 \; 97 f \\ = 0.0169 \; 7 \frac{a}{b} \\ = 0.0169 \; 7 \frac{0.0 {1}^{′′}}{0.57 {3}^{′′}} \\ = 0.000296 .\end{matrix} & ( 9 )\end{matrix}$$

The value for f is 0.01745±0.000296.

We can use Upper-Lower Bound Method of uncertainty propagation to find the uncertainty of Φ. The upper bound of f=0.01745+0.000296=0.017746 and lower bound of f=0.01745−0.000296=0.017154. These two values correspond the upper bound of Φ=1.017° and lower bound of Φ=0.983°. Based on this analysis, we know that the two-ball-measurement is accurate enough to satisfy the measurement requirement for the tapered angle dimension specification such as Φ=1°±0.05° or Φ=1°±3′.

Air gaging is another method to measure the restrictor taper angle. It is economical, reliable, accurate and suitable for shop floor production use. Properly used, it can get an uncertainty less than ±0.1°.

One can also spray the taper bore with blue dye then put real restrictor in to check how well two parts are fit, although it is not a production inspection method, but it should be helpful during machining setup stage.

This invention can definitely use straight cylinder instead of tapered cone as described above. The disadvantage is that and installation will be permanent and the advantage is that there will never be a worry about the restrictor loosing.

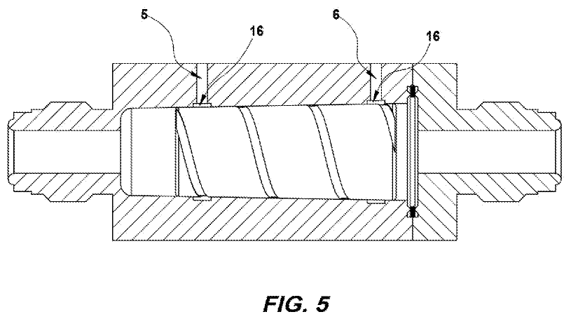

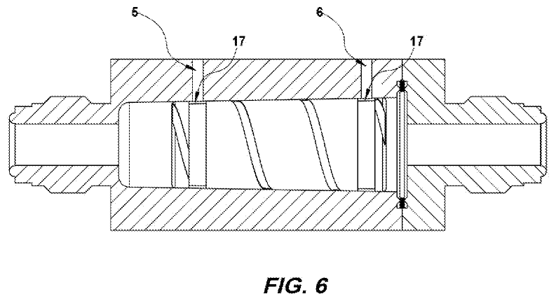

Sometimes, the length of the restrictor is longer than the distance between two taps 5 and 6, in this case, slots can be made either in base side (16 of FIG. 5) or in restrictor side (17 of FIG. 6).

What is claimed is:

1. A plug restrictor for use in a conical bore of a flow apparatus for providing a laminar flow comprising:
a primary body comprising an elongated bore, wherein at least a portion of it is conical, an inlet, an outlet and taps to communicate with a sensing device; and
a conical plug, with one or more surface channels, pressed into said elongated bore, wherein the one or more surface channels are configured to form flow passages extending between the inlet and the outlet along the inner peripheral surface of the conical bore.

2. The plug restrictor of claim 1, wherein the trajectory of the one or more surface channels are hex.

3. The plug restrictor of claim 1, wherein the one or more surface channels are straight, with a longitude direction coincident with the axis of the elongated bore.

4. The plug restrictor of claim 1, wherein the outer peripheral surface of it forms an airtight contact with the inner peripheral surface of the elongated bore.

5. A plug restrictor for use in a cylindrical bore of a flow apparatus for providing a laminar flow comprising:
a primary body, with a cylindrical elongated bore, with inlet, outlet and taps to communicate with sensing device; and
a cylindrical plug, with one or more surface channels, pressed into said cylindrical elongated bore, wherein the one or more surface channels form flow passages for fluid with the inner peripheral surface of the cylindrical elongated bore.

6. The plug restrictor of claim 5, wherein the trajectory of the one or more surface channels are hex.

7. The plug restrictor of claim 5, wherein the one or more surface channels are straight, with a longitude direction that is coincident with the axis of the cylindrical elongated bore.

8. The plug restrictor of claim 5, wherein an outer peripheral surface of it forms an airtight contact with the inner peripheral surface of the cylindrical elongated bore.
